(19) United States
(12) Patent Application Publication
(10) Pub. No.: US 2009/0237918 A1
(43) Pub. Date: Sep. 24, 2009

(54) STRUCTURE FOR ROAD LAMP WITH INTEGRATION OF WIND POWER AND SOLAR POWER

(76) Inventor: Fu-Hung YANG, Pingjhen City (TW)

Correspondence Address: SINORICA, LLC, 2275 Research Blvd., Suite 500, ROCKVILLE, MD, 20850, US

(21) Appl. No.: 12/054,351

(22) Filed: Mar. 24, 2008

(51) Int. Cl. F21L 13/00

(52) U.S. Cl. 362/183

(57) ABSTRACT

A structure for road lamps with integrated wind power and solar power comprises a solar panel, a wind turbine generator, an electrically controlling apparatus, a battery, a road lamp, an electric box, a fixing ring, locking rings and a base. It is an independent system to be mounted around a traditional road lamp pole or any pole standing on. The structure utilizes the solar and wind power generated, being used for lighting in the dark. It is not connected either to any power generation service or to the traditional road lamp on the original pole.

### BACKGROUND OF THE INVENTION

1. Field of the Invention

The present invention relates to a structure for road lamps with wind/solar power, the road lamps being capable of replacing traditional road lamps, and, particularly, to a structure for road lamps with integrated wind power and solar power and designed for the road lamps to have independent lighting operation but still to be disposed around the road lamp poles, so that the road lamps can be mounted onto desired locations easily to gather natural energy resource for generation, can be mounted simply to help popularize natural energy resource and related products to the herd, can facilitate an access to wind power and solar power for use in lighting the lamps, and can achieve the highest efficiency of wind power and solar power.

2. Descriptions of the Related Art

Utilization of traditional electric power for city lighting is one of people's biggest uses. Tremendous amount of traditional power consumed, in dark, for lighting city's highways and public domains has resulted in very heavy loads on the existing thermal power plants and has also caused pollution on the Earth. As such massive consumption proceeds, the energy resources of the Earth will be used up in a short time and, for the worst, the Earth's environment can be destroyed. The living environment on the Earth was changed in a terrible manner after the Industrial Revolution; as a result, such phenomena as greenhouse effect, El Nino effect, various pollutions, desertification of green lands and acid rain occur altogether.

In the present days, the road lamps rely on traditional electricity widely and considerably. A minority of road lamps uses wind/solar power whereas these lamps may be short of electricity temporarily due to insufficiency of the natural conditions. The popularization of road lamps with wind/solar power is limited in certain ways. Firstly, since the traditional road lamps have ideal structures and the road lamps with wind/solar power has high unit prices to construct, it is extravagant and generally unacceptable to take out the poles for the former oddly and to stand up ones for the latter instead. Although the governments are often forced to popularize the utilization of natural energy resources, they may just adopt the road lamps with wind/solar power regionally. However, a region may have different climates in different seasons and, therefore, sometimes electricity may not be available, in bad natural conditions such that one has raining or snowing while has no winding, for the road lamps with wind/solar power to work. The road lamps with wind/solar power, as not being able to provide lighting routinely, cannot be appreciated by the populace.

It is necessary to improve the difficult situations described above. For this purpose, it may be the most preferable choice to adopt two sets of lamps with respective power supplies per pole. Of the two sets, one is a primary set of lamps with wind/solar power, which may have a utilization rate of about 5/6; the other one is an auxiliary set of traditional lamps, which may have a utilization rate of about 1/6. The traditional lamps may be lighted with traditional electric power as a relay when the lamps with wind/solar power break. Accordingly, it is hopeful to allocate lamps with wind/solar power independently onto original poles for the traditional lamps. This method of using two set of lamps may be carried out to save the Earth's energy resource.

In view of the aforesaid shortcomings, the inventors have endeavored to make innovation and, eventually, developed the present structure and an associative method of application for the road lamps with wind/solar power that is capable of replacing traditional road lamps.

### SUMMARY OF THE INVENTION

The primary objective of this invention is to provide a structure for road lamps with wind/solar power that is capable of replacing traditional road lamps, wherein an independent set of road lamps with wind/solar power is mounted onto a pole for traditional road lamps so that there are two set of road lamps with respective power supplies on one pole and the set of road lamps with wind/solar power is the primary one for lighting while the set of traditional road lamps functions in an auxiliary manner in which the traditional road lamps are controlled to switch on for lighting when the road lamps do not work (for example, under insufficient natural conditions). Thus, the present invention can utilize natural energy while take advantage of traditional electric energy.

Another objective of this invention is to provide a structure for road lamps with wind/solar power that is capable of replacing traditional road lamps, wherein the road lamps with wind/solar power can be easily mounted onto an original pole for traditional lamps in only 1-2 hours so that dismounting, displacing, maintaining and disaster securing can be performed easily and the electricity for lighting is available at any time.

To fulfill the above mentioned objectives, a structure for road lamps with wind/solar power that is capable of replacing traditional road lamps comprises: a fixing ring for providing a support for the entire structure, the fixing ring being aligned with the Arctic-Antarctic direction (the workers working on a lift vehicle may be guided by the co-workers on the ground.) and fastened on a lamp pole 10 by screws, so that a mounted solar panel can be oriented to the Antarctic as desired; an electric box roofed with a solar panel, being hung up on the fixing ring and fastened on the lamp pole by screws, through one upper locking ring and one lower locking ring; a solar panel, being disposed as a roof over the electric box and thus hung high up over the lamp pole, the solar panel being inclined from the horizon by 20 degree; a wind turbine generator, being hung up on the fixing ring and opposite to the electric box (in the direction of Arctic), and fastened on the lamp pole by screws, through one upper locking ring and one lower locking ring; a road lamp, being hung up under the electric box, facing the area to light (e.g., the road center), and being fastened on the lamp pole by screws, through one upper locking ring and one lower locking ring. Into the electric box, there may be an electrically controlling apparatus and a battery mounted, wherein to the electrically controlling apparatus, the solar panel, the road lamp and the battery are wired electrically. The electric box may have a door, which may be closed and locked after a test on the function of the inventive road lamp is finished.

The procedure of dismounting is the reverse to that of mounting as described above, being performed on a lift vehicle as well. The operation is rather easy because the fixing ring has provided such a support that people need not worry about looseness of screws and drooping of parts in the structure. The solar panel, the electric box, the wind turbine generator and the lamp are fastened individually on the pole, being held more intensively, so that the structure is safer and can be maintained by parts more easily.

In case that a brand new system of road lamp is to be stood up, it is desirable to adopt two sets of road lamps with respective power supplies, wherein one set of road lamps with wind/solar power in the present structure is the primary one for lighting while the other one set of traditional road lamps is retained and functions in an auxiliary manner. The traditional road lamps may be switched on under insufficient natural conditions. The parts of the structure may be mounted according to the present invention, in which the solar panel has to be so mounted, for achieving the largest generated power, as to have the orientation to the Antarctic, depending on the actual situations.

The structure for road lamps with wind/solar power may also be screwed up into an entirety as a mobile power supply. It can be used by those including troops, farmers, working teams, fish men and camps. Wind and solar energies can be acquired for generation, by placing the structure somewhere at high altitude and in orientation to the Antarctic. With the natural energy, road lamps can be lighted or, alternatively, electric appliances can be powered through power cables.

Refer to one preferred embodiment of the present invention through the following description and drawings. The embodiment illustrates the technique, objectives and functions further.

### BRIEF DESCRIPTION OF THE DRAWINGS

The drawings for the embodiment are as follows:

FIG. 1 is a perspective view for the present invention;

FIG. 2 is a schematic diagram of relative locations in the structure according to the present invention;

FIG. 2B is a schematic diagram of relative locations in the structure according to the present invention, with the location of the road lamp transformed from that in FIG. 2;

FIG. 3A-3D are schematic diagrams of relative locations in the sequence of mounting according to the present invention;

FIG. 4 is a schematic diagram of the mounted structure as a mobile power supply according to the present invention; and

FIG. 4A is a schematic over view of the structure according to the present invention.

### DESCRIPTION OF THE PREFERRED EMBODIMENT

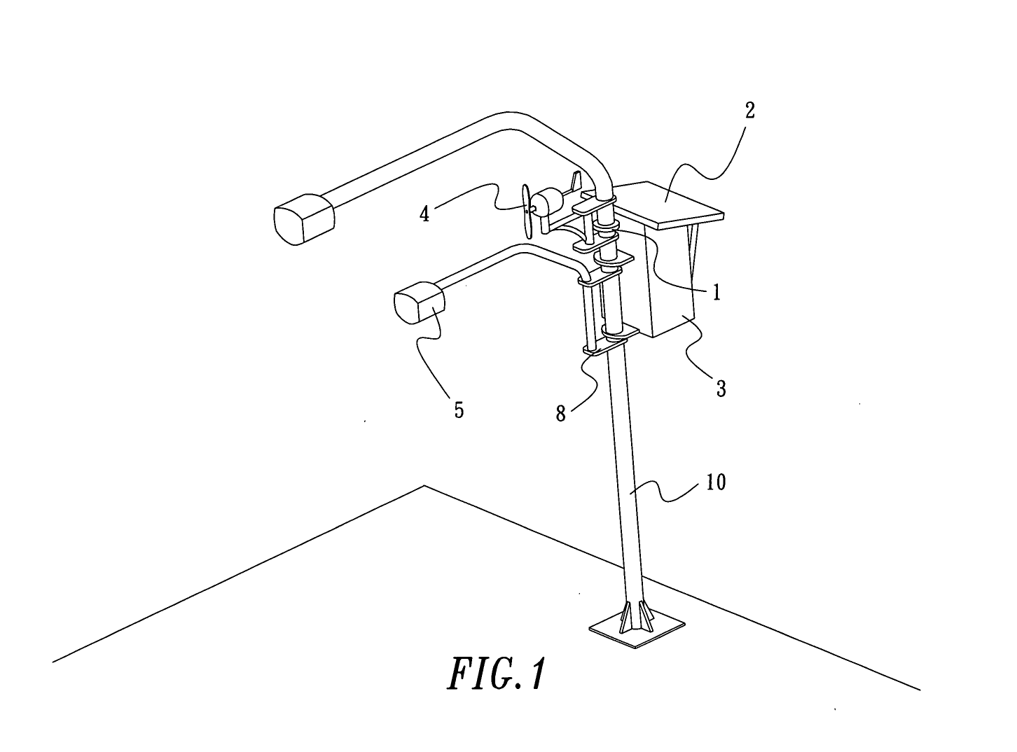

Refer to FIG. 1-4A. The present invention provides a structure for road lamps with wind/solar power, the road lamps being capable of replacing traditional road lamps, and, particularly, to a structure for road lamps with integrated wind power and solar power. According to the present invention, the structure for road lamps with wind/solar power comprises a fixing ring 1, a solar panel 2, an electric box 3, a wind turbine generator 4, a road lamp 5, an electrically controlling apparatus 6, a battery 7 and a locking ring 8.

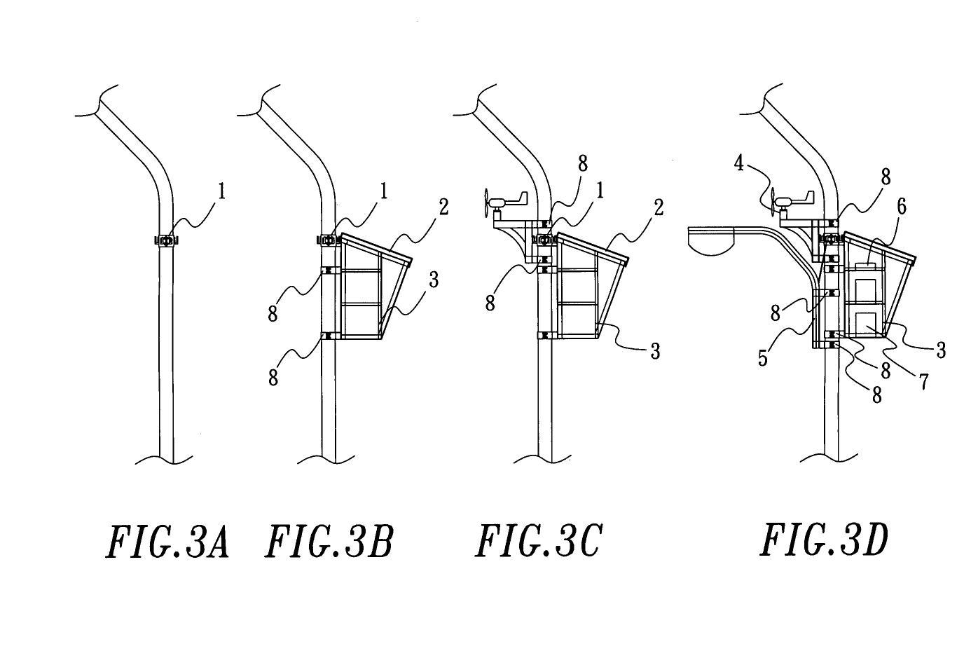

The fixing ring 1 provides a support for the entire structure, being aligned with the Arctic-Antarctic direction and fastened on a lamp pole 10 by screws (FIG. 3A), so that the solar panel 2 can be oriented to the Antarctic as desired. The electric box 3 with the solar panel 2 is hung up on the fixing ring 1 while the solar panel 2 is hung high up over the lamp pole 10 and oriented to the Antarctic. Then, the electric box 3 is fastened on the lamp pole 10 by screws, through one upper locking ring 8 and one lower locking ring 8 (FIG. 3B). The wind turbine generator 4 is hung up on the fixing ring 1, as being opposite to the electric box 3 (in the direction of Arctic), and fastened on the lamp pole 10 by screws, through one upper locking ring 8 and one lower locking ring 8 (FIG. 3C). The road lamp 5 is hung up, under the electric box, on the fixing ring 1 by a suspension rope 51, facing the area to light (e.g., the road center), and fastened on the lamp pole 10 by screws, through one upper locking ring 8 and one lower locking ring 8 (FIG. 3D). Into the electric box 3, there may be an electrically controlling apparatus 6 and a battery 7 mounted, wherein to the electrically controlling apparatus 6, the solar panel 2, the road lamp 5 and the battery 7 are wired electrically. The electric box 3 may have a door, which may be closed and locked after a test on the function is finished.

The procedure of dismounting is the reverse to that of mounting as described above, in which the wires are removed firstly and, then, the electrically controlling apparatus 6, the battery 7, the road lamp 5, the wind turbine generator 4 and the electric box 3 are removed in sequence. The operation is rather easy because the fixing ring 1 has provided such a support that people need not worry about looseness of screws and drooping of parts in the structure. The electric box 3 roofed with the solar panel 2, the wind turbine generator 4 and the lamp 5 are fastened individually on the pole 10, being held more intensively, so that the structure is safer and can be maintained by parts more easily.

Accordingly, function of lighting can be provided by both the road lamp 5 and a road lamp 11 on the pole 10. Usually, solar energy acquired by the solar panel 2 and wind energy by the wind turbine generator 4 may be supplied and stored through the electrically controlling apparatus 6 and the battery 7, for lighting the road lamp 5. It meets the requirement of environment protection and energy saving. In case that both the natural energy resources are short, the traditional road lamp 11 can be used for lighting.

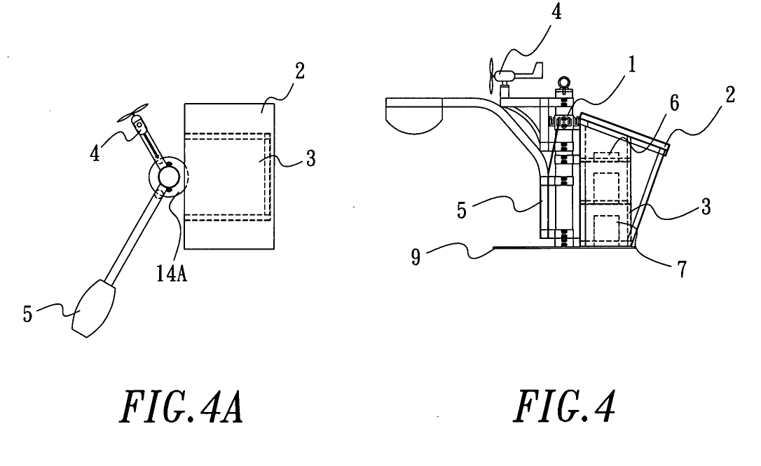

The structure for road lamps with wind/solar power may also be screwed up into an entirety, or screwed up onto a base 9 (FIG. 4) to be placed flatly or fixed on the ground. It can serve as a mobile power supply, used by those including troops, farmers, working teams, fish men and camps. Wind and solar energies can be acquired for generation, by placing the structure somewhere at high altitude and in orientation to the Antarctic. With the natural energy, road lamps can be lighted or, alternatively, appliances can be powered through power cables.

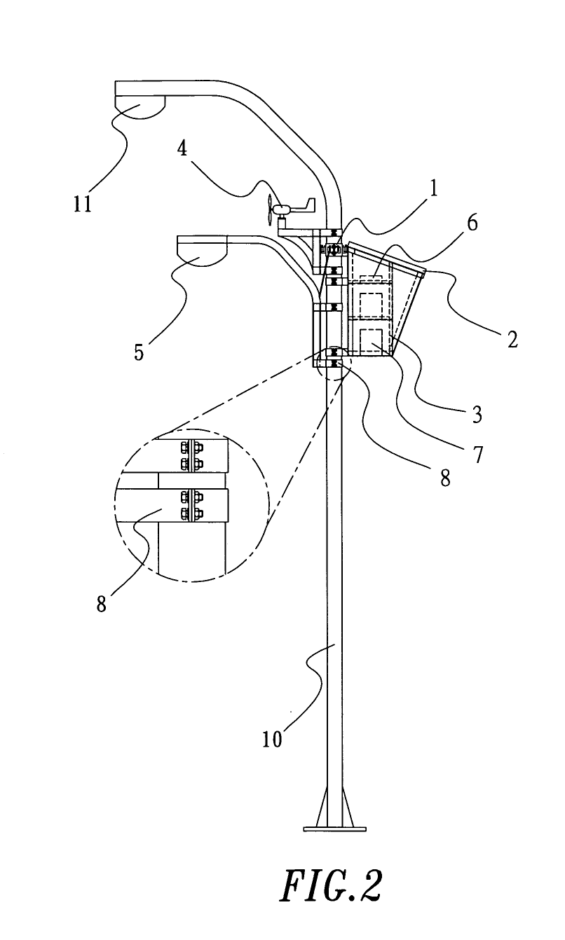

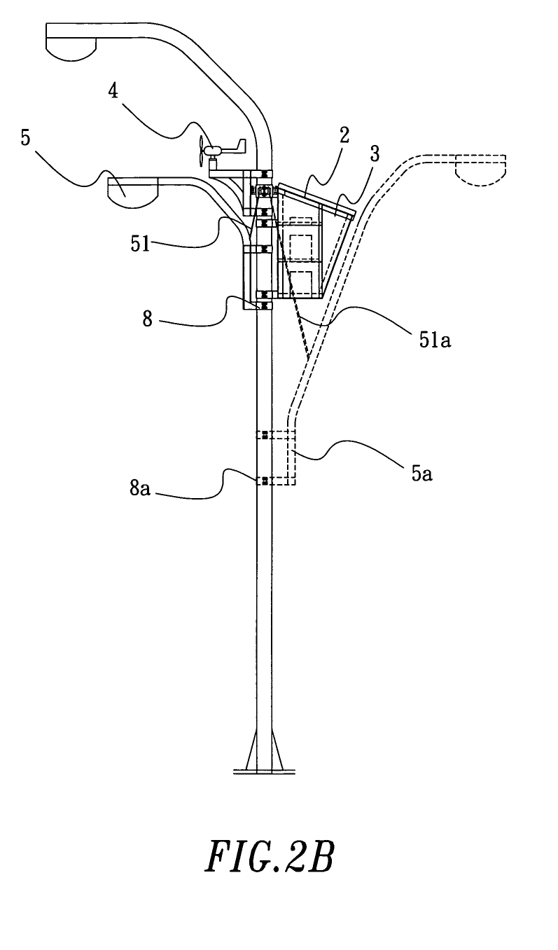

The wind turbine generator 4 and the road lamp 5 described above may be adjusted through the locking rings 8 so that the wind turbine generator 4 is oriented to face the wind flow and thus obtains the highest efficiency of wind power, and that the road lamp 5 faces rightly the area to light (FIG. 4A). Moreover, it is preferred that the locking rings 8 for the road lamp 5 is disposed over and under the electric box 3, respectively; otherwise, the road lamp 5 may lap with the electric box 3 as the road lamp 5 rotates. Optionally, as shown in FIG. 2B, a road lamp 5a associated with locking rings 8a are fastened in an alternative location on the pole 10 so that the road lamp 5a cannot touch the electric box 3 when rotating; the road lamp 5a may be further stabilized by a disposed suspension rope 51a.

The above description refers to one preferred embodiment of the present invention. It is, however, intended to limit the invention. Many changes and modifications in the above described embodiment of the invention can be carried out without departing from the scope thereof. The invention is to be limited only by the scope of the appended claims.

What is claimed is:

1. A structure for road lamps with integrated wind power and solar power, comprising:
a fixing ring, fastened on a road lamp pole, and being for said structure to be hung and positioned;
an electric box, hung up on the Antarctic edge of the fixing ring and fastened on the road lamp pole, and being for mounting a solar panel, an electrically controlling apparatus and a battery;
a solar panel, fastened as a roof over the electric box, and being for solar power generation;
a wind turbine generator, hung up on one edge of the fixing ring and fastened on the lamp pole, and being for wind power generation;
a road lamp, hung up on the fixing ring and under the electric box, facing the area to light and fastened on the road lamp pole, and being for lighting;
an electrically controlling apparatus, disposed inside the electric box and receiving and integrating the solar and wind power generated, which is input to and stored in a battery, the electrically controlling apparatus being for controlling the time slot of lighting and for managing the access of power from the battery;
a battery, disposed inside the electric box and managed by the electrically controlling apparatus, and being for storing the solar and wind power generated and for supplying power to the road lamp or to electric appliances; and
a locking ring, fastened on the road lamp pole, and being for positioning and securing the electric box, the wind turbine generator and the road lamp.

2. The structure for road lamps with integrated wind power and solar power according to claim 1, wherein the structure further comprises a base which is to support the structure placed on the ground, serving as a mobile power supply.

3. The structure for road lamps with integrated wind power and solar power according to claim 1, wherein the solar panel and the wind turbine generator are fixed on the Antarctic edge and the Arctic edge of the fixing ring, respectively, to fit to the local geography condition.

4. The structure for road lamps with integrated wind power and solar power according to claim 1, wherein the fixing ring, the locking ring and the structure are designed for easily mounting and dismounting so that the structure can be mounted on the road lamp pole readily.

5. The structure for road lamps with integrated wind power and solar power according to claim 1, wherein the lamp has a suspension rope attached thereto, the suspension rope being used for assisting in hanging and stabilizing the road lamp on the road lamp pole.
